(19) United States
(12) Patent Application Publication
(10) Pub. No.: US 2002/0149566 A1
(43) Pub. Date: Oct. 17, 2002

(54) Key-surround module inputting device

(76) Inventor: Arthur H. Sarkissian, New York, NY (US)

Correspondence Address: Arthur H. Sarkissian, 3 Hanover Square, Apt. # 14G, New York, NY, 10004, US

(21) Appl. No.: 09/835,884

(22) Filed: Apr. 16, 2001

(51) Int. Cl. G09G 5/00

(52) U.S. Cl. 345/168

(57) ABSTRACT

A computer inputting device consists of a key, keys, a plural-directional plural-value pivotable key-inputting surrounding or surroundings, key-arrangement inputting surrounding or surroundings or a combination thereof, which due to their structure or placement form an inputting key-surround module or inputting key-surround modules. Each key or key-surrounding, though it may not necessarily surround, be circular in shape nor be concentric with respect to its “central” key, keys or key-surrounds, has a plurality of inputting key actuating constructs beneath. Such key-surround module or modules, respective components or a combination thereof may be stationary, displaced, rotated or a combination thereof, separately or in units, with an underlying support or a system of supports. The user is able to input conventional inputting values with more inputting space efficiency, greater accuracy, less requirement for exacting inputting movements than with that of a conventional inputting device, complete tactile familiarity, the availability of more key values than with conventional inputting devices, the availability of larger and conveniently shaped keys for ease of inputting with other keys, an increased awareness of the location of key values, a similar key resistance-feel as with that of conventional inputting devices, and with the ability to displace key value components while maintaining conventional Qwerty inputting device finger-to-key relationships.

### REFERENCES CITED

Patent No. 3, 499,515 03/1970 Mikrut . . . . 197/98

Patent No. 4, 579,470 04/1986 Casey . . . . . . . . . . . . 400/486

Patent No. 4, 597,681 07/1986 Hodges . . . . . . . . . . . 400/488

### BACKGROUND

The present invention relates to an inputting device, and more particularly to the novel Key-Surround Module (Hereinafter KSM) inputting device whereby a key, keys, key-arrangement key-surrounding or key-surroundings, floating pivotable key-surrounding or key-surroundings or a combination thereof is or are fully or partially surrounded by a key, keys, a key-arrangement key-surrounding or key-surroundings, floating pivotable key-surrounding or key-surroundings or a combination thereof, which can be described as a module or modules.

The following paragraph provides a mere clarification of the meaning of terms as used throughout the specification and the claims:

The term “inputting device” may refer to any device which is used to input information of any kind to a computer or machine with keys of any sort used to convey information, values or instruction electrically, chemically, magnetically, mechanically or a combination thereof. The term “rest-position keys” may refer to key value areas on an inputting device upon which the user rests inputting fingers of each of her hands before and after inputting strokes. Rest-position keys of the conventional Qwerty inputting device format have the following values from left to right on a conventional Qwerty keyboard: “A”, “S”, “D”, “F”, “J”, “K”, “L and “;”. The term “Qwerty key values” may refer not only to those key values associated with the inputting of letter-characters or numerals, rather, it may also denote all function keys and all computer or electronic device keys which may or may not be found on every Qwerty inputting device. The term “key value” may refer to the intended character, function, task, movement or signalling that the user is seeking to actuate with the pressing of any given inputting area. The term “KSM key” may refer to a capacitive key with one or a plurality of actuating constructs beneath, an hard-contact key with one or a plurality of actuating constructs beneath, a floating pivotable key with one or a plurality of actuating constructs beneath or a combination thereof, with a size, shape, placement and movement in order to facilitate inputting with other KSMs or a combination thereof The term “key-surrounding” may refer to a key which not necessarily entirely surrounds another key, serves to facilitate the inputting of one or a plurality of key values, has beneath it one or a plurality of actuating constructs or a combination thereof The term may also refer to both three-dimensional or two-dimensional keys depending upon the medium. A “key-surrounding” may refer to a single key or to a plurality of keys of the Key Surround Module Inputting Device. The terms “Key-Surround Module”, “Key-Surround Module Inputting Device”, “Key-Arrangement Key-Surround Module Inputtting Device” and “Floating Pivotable Key-Surround Module Inputtting Device” may refer in the Specification and in the claims both to inputting devices in the most narrow sense interpretable in the claims and to inputting devices in the most broad sense interpretable in the claims where they may comprise only a part. The term “support” or “supports” may refer to both three-dimensional supports or backings and to two-dimensional surfaces, screens, monitor displays or backgrounds. The term “touch-sensitive surface” may refer to both any surface which is exposed, obvious, in direct contact with the user or a combination thereof, and to that which is concealed, internal, indirectly in contact with the user or a combination thereof, which may be used to actuate any signal or signals in the inputting process either electrically, chemically, magnetically, mechanically or a combination thereof The term “actuating construct” may refer to any underlying electrical, chemical, magnetic, mechanical means or a combination thereof, involved in the signaling process during inputting. The term “module” may refer to a moveable component or components and may refer to a stationary sectioning or arrangement of keys with or without structural divisions which may be thought of as a unit; for example, where keys due to their structuring, placement, proximity, appearance or with regards to their relationship or designation to a given inputting finger or hand of the user may be thought of as comprising a unit or units.

In the case of a Floating Pivotable Key-Surround Module (Hereinafter FP-KSM) inputting device, the user may rest her finger on a “central” key and extend to one of any number of adjacent key-surroundings and be able to input a plurality of key values. Said key-surroundings may be pivotable and may have a plurality of actuating constructs beneath. With regard to a Key-Arrangement Key-Surround Module (Hereinafter KA-KSM) inputting device, the user may extend from a “central” key, for example, a rest-position key, to any one of a plurality of adjacent key-surroundings, inputting a plurality of key values on the same key-surrounding. The FP-KSM or the KA-KSM may be pressed with the same force required by that of a standard key of a conventional Qwerty inputting device when inputting. The user of a KSM inputting device may rotate and displace a KSM in a plurality of directions in order to discover comfortable and ergonomic positions from which to input. An FP-KSM, FP-KSMs, a KA-KSM, KA-KSMs may, in part, individually, in plurality, in combination or a combination thereof comprise a KSM.

One disadvantage of conventional inputting devices concerns the fact that they contain keys with chiseled square key tops which are intended to distinguish them from nearby keys, and to theoretically avoid the user's inadvertent pressing of adjacent keys on the space-limited conventional inputting device. This conventional characteristic of the conventional Qwerty inputting device makes inputting difficult in that due to the limited inputting surface area and close proximity to one other, these conventional Qwerty keys are difficult for the user to accurately strike. Moreover, given this arrangement and the limited space of the standard inputting surface, laptop computer keyboard or hand-held computer, the user must pay constant and careful attention to the inputting device and her to the positioning of her fingers and hands in relation to the inputting device in order to input with accuracy. Often the user must look at the inputting device to insure her accuracy or else risk striking a key at other than its center, make inputting errors and thereby cause frequent repetition, loss of work-time and frustration.

Another disadvantage of prior art concerns the grid-like placement of keys on the conventional inputting device. For example, U.S. Pat. No. 3,499,515 for a modular electric keyboard features a plurality of inputting keys along with Qwerty rest-position keys which are identically sized, shaped and placed in rows on the inputting device. The result is that the user cannot differentiate by touch amongst the keys in the rest-position key row and may thus easily and accidentally rest her fingers on the wrong keys. The user will frequently input from this incorrect placement and consequently have to re-input. In addition, the minute protrusions which are placed on some standard Qwerty inputting devices do not provide a remedy for this problem because they are hard to detect by touch due to their necessarily small size. Secondly, the user has difficulty inputting the values for the other keys of the conventional inputting device because she is not always sure if she is inputting too “high” or too “low” on the surface of the conventional Qwerty inputting device.

Another disadvantage of prior art concerns the grid-like structure of the conventional Qwerty inputting device key placement, where much of the key surface areas are taken by the corners of conventional Qwerty square keys. The corners of these keys are a function of the entire grid-like structure of the conventional Qwerty inputting device and are an inefficient use of space, whereas other key values might be placed in such un-used spaces. Secondly, the grid-like placement of conventional Qwerty inputting device keys provides a rigid and unnatural placement of keys which is incompatible with the natural curvature of the user's finger tips when the user's hand is at rest on the inputting device.

Another disadvantage of prior art concerns the repositioning of keys. For example, U.S. Pat. No. 4,597,681 provides for conventional Qwerty keys which can be re-positioned with respect to the angle made by their surfaces and the keyboard surface. The disadvantage is that it is quite tedious and time-consuming for the user to have to alter the position of each of the many keys separately rather than in groupings. Additionally, the problem becomes more burdensome when more than one user wishes to make use of the same inputting device.

Another disadvantage of prior art concerns the attempt at changing the conventional position of Qwerty key values on an inputting device. U.S. Pat. No. 4,579,470 provides an arrangement of keys thereby changing conventional Qwerty key value placements and finger-key relationships. The result is that the user is forced to learn new key positions after already having learned or mastered traditional Qwerty key value placements and finger-key relationships. This has in recent history been shown to be undesirable by consumers of inputting devices.

Another disadvantage of prior art inputting devices concerns the lack of visual instructiveness of such conventional inputting devices. It is not always clear to the new user just which keys are to be stricken and by which rest-position fingers. If the user has not previously been instructed as to peculiarities of finger-to-key work delegation in inputting, or if the user's memory has not been refreshed as to these relationships, it is difficult for the user to realize finger-to-key inputting relationships with conventional inputting devices.

Another disadvantage of the conventional Qwerty keyboard concerns frequently used keys such as, but not limited to, “the Space bar”, “the Enter key”, “the Back Space key”, “the Shift key”, “the Tab key”, “the Caps Lock key”, “the Ctrl key”, “the Alt key”, all “Function” keys and the mouse, trackball, touch-pad or other pointer-navigating devices. On the conventional Qwerty inputting devices these keys are placed at the extreme ends and corners of the device. Hence, these keys are difficult for the user to reach while inputting on the conventional Qwerty inputting device. In addition, due to the limited space available on the conventional Qwerty inputting device, these hard-to-reach keys are also not very larger than the other keys. Further, because of their sizes and shapes, these keys are hard to distinguish from the other Qwerty keys while inputting.

Still another disadvantage to the prior art is that whereas the conventional Qwerty computer inputting device, due to the monotonous positioning of its keys, the unnatural and hard-to-reach placements of its keys and the potentially injurious nature of its overall form, in particular with regard to the affect upon the user specifically with regard to Carpal Tunnel Syndrome and other strain injuries, has become an object for the user's fatigue and injury.

### SUMMARY

Accordingly, it is a general object of the present invention to overcome the disadvantages of prior art.

More particularly, it is an object of the present invention to provide a computer inputting device whereby a key, keys, a floating pivotable key-surrounding, floating pivotable key-surroundings, a key-arrangement key-surrounding, key-arrangement key-surroundings or combination thereof each of which have one or a plurality of electrical, chemical, magnetic, mechanical actuating constructs or a combination thereof beneath, are fully or partially surrounded, concentrically or non-concentrically, circularly, or non-circularly or a combination thereof by a key, keys, a floating pivotable key-surrounding, floating pivotable key-surroundings, a key-arrangement key-surrounding, key-arrangement key surroundings or a combination thereof which have one or a plurality of actuating constructs beneath. The above may also be made displaceable or rotatable in a plurality of directions or a combination thereof in parts, units or a combination thereof.

Another object of the present invention is to provide a computer inputting device, in particular a KSM inputting device, which allows the user to input Qwerty key values and electronic device key values with greater accuracy than with that of prior art inputting devices. The new KSM inputting device structurally increases inputting surface area and accuracy for all inputting areas associated with every traditional Qwerty key value and electronic device key value.

The key-surroundings of the FP-KSM need not have confining physical boundaries nor wasteful chiseled corners between inputting keys. Rather, they extend, allowing one inputting characters' space to flow to the next increasing the inputting surface area for each key value. These inputting surface areas may cover a capacitive key actuating construct, a plurality of capacitive key actuating constructs, an hard-contact key actuating construct, a plurality of hard-contact key actuating constructs, a plural-directional capacitive key actuating construct, a plural-directional hard-contact key actuating construct, a touch-sensitive surface or touch-sensitive surfaces beneath, or other appropriate electrical, chemical, magnetic, mechanical signaling devices or a combination thereof With the FP-KSM, the user need not press a limited point on the inputting device. Rather, she may press any spot on an entire area of the key-surrounding which corresponds to the designated Qwerty key value or electronic key value. It is more likely that the user is accurate where there is a plurality of key actuating constructs beneath the FP-KSM inputting device rather than with that of the conventional Qwerty inputting device having only one conventional key actuating construct beneath each Qwerty key. In addition, the user may displace and rotate the FP-KSM inputting device and its parts in order to accommodate any directional finger movement and extension which may, on the conventional Qwerty inputting device, result in inaccurate typing, thereby, increasing the user's inputting accuracy. The user is thus given more freedom to input less exactingly, however, without having to forego inputting accuracy. The FP-KSM thereby increases overall inputting accuracy and inputting efficiency.

The key-surroundings of the KA-KSM do not have confining physical boundaries nor wasteful chiseled edges between inputting surfaces. Rather, they extend, thereby increasing the surface area for each key value. These inputting surface areas may cover a capacitive key actuating construct, a plurality of capacitive key actuating constructs, an hard-contact key actuating key construct, a plurality of hard-contact key actuating constructs, a plural-directional capacitive key actuating construct, a plural-directional hard-contact key actuating construct, a touch-sensitive surface or touch-sensitive surfaces beneath, or other appropriate electrical, chemical, magnetic, mechanical signaling devices or a combination thereof, and thus, offer Qwerty key values or electronic key values a plurality of such constructs. In addition, the user may displace and rotate the KA-KSM inputting device and its parts in order to accommodate any directional finger movement and extension which may otherwise result in inaccurate typing, thereby, further increasing the user's inputting accuracy. The user is thus given more freedom to input less exactingly and without compromising accuracy, thereby, increasing overall accuracy and inputting efficiency.

Yet another object of the new KSM inputting device is to allow the user to maintain the placement of her fingers on rest-position keys without having to look at the inputting device for confirmation of correct finger positioning. A KSM inputting device may be such that modules are allotted for each rest-position key. Hence, rest-position keys once known are easily recognized by touch and there is no need for the user to visually verify her finger placement. Since rest-position keys are, whether entirely or partially “surrounded”, concentrically or non-concentrically, circularly or non-circularly or a combination thereof, by a key-surrounding or key-surroundings, the user at all times knows from her sense of touch that she is inputting from rest-position keys and can thus always avoid misplacing her fingers and thereby prevent inputting incorrectly. With regard to other Qwerty key values or electronic key values, the KSM allows the user to feel along each key-surrounding and thereby not extend too “high” or too “low” on the surface of the inputting device for a certain key value. Thus, the KSM further increases inputting device awareness without distracting the user for visual confirmation. Secondly, whereas there are “levels” of inputting on the KSM depending on which key-surrounding the user is inputting upon, it is clear to the user's tactility whether or not she is extending her fingers too “high” or too “low” on the surface of the KSM inputting device. The user needs only to feel for key-surroundings. Additionally, a certain entire KSM key-surrounding or key-surroundings or points or areas on the KSM key-surroundings, or a combination thereof, may be constructed at higher or lower levels than others with respect to the level of the inputting surface, at different inclines and with different texturizations or a combination thereof. These variations of keys and of key-surroundings thereby further increase the user's tactility of areas of inputting.

Another object of the new KSM inputting device is the creation of free space heretofore unavailable with prior art inputting devices.

Each FP-KSM key-surrounding contains the inputting surface of a plurality of key values. There is no physical division between Qwerty key value inputting areas on said key-surroundings. Rather, there is a flow of inputting surface area from one key character to the next. For this reason there is no wasted space between key character inputting areas. Secondly, the curvatures of the key-surroundings of the FP-KSM, along with the placement of a plurality of these surroundings about rest-position keys further saves surface space. The result is that conventional Qwerty key value inputting is achieved in less space than that which can possibly be achieved with conventional Qwerty inputting devices. Further, there is the creation of free space with the KSM inputting device, space which is inefficiently used with conventional Qwerty inputting devices. Keys which are conventionally far from the user's reach are brought closer to the rest-position keys and added on the key-surrounds of the KSM inputting device. Thus, the FP-KSM offers both an economy of space for Qwerty key value inputting and further frees space for the addition of other key values.

With regard to a KA-KSM, each key-surrounding likewise contains the inputting surface of a plurality of key characters. The curvature of the surroundings of the KA-KSM, along with the placement of a plurality of these surroundings about rest-position keys further saves surface space. The result is more key value inputting in the same amount of space as that of the conventional Qwerty inputting device. Whereas there is far more free space on the KA-KSM inputting device as compared to that of the conventional Qwerty inputting device, keys which are conventionally far from the user's reach are brought closer to rest-position keys and added to key-surroundings of the KA-KSM inputting device. Thus, the KA-KSM offers both an economy of space for Qwerty key value inputting and further frees space for the addition of other key values.

Secondly, with regard to all KSMs, and whereas all KSM keys, key-surrounds, modules, their respective components, individually and units thereof, may be rotated, displaced in a plurality of direction, made concentric or non-concentric with respect to one another or a combination thereof, the KSM inputting device allows the user to alter her inputting area in order to accommodate the natural and unique curve of the points of the user's finger tips at rest on the inputting device. By the same means, the KSM accommodates the natural and peculiar finger movement of any user in allowing the user to alter the positions of origins and destinations of finger movement in order to find the most comfortable and least stressing directions of inputting motion.

Additionally, the KSM inputting device brings all keys, which on prior art Qwerty inputting devices are difficult to reach, difficult to recall and difficult to mentally or visually assign with regard to rest-position-key fingers, closer to KSM rest-position keys. Because of the structure of the KSM, all conventional Qwerty key values and electronic key values are brought closer together in the creation of free space described above. As a consequence, function keys and number key values of the conventional Qwerty inputting device are easier for the user to reach, visualize, recall and relate to appropriate rest-position-key fingers. KSM reduction of inefficient conventional Qwerty inputting device use of space functions to reduce the user's required finger extension and, thereby, reduces inaccurate finger extensions by the user. Thus, with the KSM, rest-position key value to other key value inputting is facilitated whereas Qwerty inputting devices contain keys which are relatively far on the inputting device from the rest-position keys. Consequentially, the KSM reduces conventional Qwerty inputting device confusion and further encourages the use of conventionally “distant” Qwerty inputting device key values.

Another object of the KSM, with its key-surroundings and rest-position keys, is to allow the user to arrange a plurality of key value inputting surfaces in units rather than having the user change the position of each key as with prior art inputting devices. With the new KSM inputting device the user may change a plurality of key placements by simply displacing one key, key-surround, module or pod containing a plurality of keys and modules.

When the KSM or parts of the KSM is or are displaced to accommodate the comfort and physicality of the user, rest-position keys may be moved in unison with their conventionally assigned and related inputting keys, thereby, maintaining traditional rest-position key and other key relationship integrity. It is far more convenient to move the position of a module, modules, a key-surrounding or key-surroundings of a KSM inputting device than it is to re-position individually tens of conventional Qwerty keys as with prior art. Further, and with regard to a KSM inputting device with computer controlled motors, each user may automatically change the KSM inputting device to her own preference and save the positions in memory for future inputting, thereby, allowing the user to avoid repeating the process of finding ideal inputting positions.

An additional object of the new KSM inputting device is to refrain from the deletion or alteration of traditional Qwerty key value patterns and the relationships of key values to their traditionally designated inputting fingers.

With the new KSM inputting device there is no need for the user to learn new key placements and finger-to-key relationships. Key values placed on the KSM are located in the same position-relationships as those of the conventional Qwerty inputting device. The KSM leaves conventional Qwerty finger-to-key position relationships unchanged. Thus, new users of the KSM are not required to re-learn a new placement of keys as has been the case with prior art. The user can without difficulty apply her present Qwerty inputting knowledge and skill to the KSM computer inputting device. Hence, the new KSM offers easy adaptability, making it a welcomed innovation to inputting.

Additionally, the KSM offers keys and key-surroundings which have a resistance-feel when pressed which is similar to those of conventional Qwerty inputting devices. Thus, the user when inputting with a KSM feels she is inputting on a conventional inputting device with regard to key resistance-feel. With KSM the user is not forced to become accustomed to a distracting feel in inputting.

Another object of the KSM inputting device is to obviously indicate finger placement and finger-to-key relationships to the user. It is clear to the user from first glance at a KSM inputting device, for example, that certain rest-position fingers are responsible for inputting certain key values on certain key-surroundings.

The module nature of a KSM, having a rest-position key with a devoted key-surrounding or key-surroundings, visually indicates to the user as to which key values correspond to which rest-position keys. The new KSM inputting device is thus also revolutionary from the standpoint of inputting beginners. The first-time user and those who have forgotten Qwerty finger-to-key relationships will clearly decipher traditional finger-to-key relationships from the form of the KSM. Also, the new KSM user may easily memorize and recall entire key-surroundings containing a plurality of key values. Thus, learning how to input with the KSM is easy and enjoyable.

Still Another object of the KSM is to provide key values such as, but not limited to, “the Space bar”, “the Enter key”, “the Back Space key”, “the Shift key”, “the Tab key”, “the Caps Lock key”, “the Control key”, “the Alt key”, “the Escape key”, all “function” keys, mouse, trackball, the touch-pad, other pointer-navigating devices or other frequently used keys with large and appropriately shaped KSM keys in order that they accommodate other KSM inputting keys. A KSM inputting device may comprise these frequently used keys in larger, easier to reach, easier to press, and conveniently shaped keys in order to best accommodate other KSM keys and or key-surroundings while inputting. For example, the KSM may contain a curved and large “Enter key” KSM to be placed under rest-position key KSMs, thereby, enabling an easier reach from any number of the user's rest-position key fingers. In addition, other keys including but not limited to keys such as “the Shift key”, “the Control key”, “the Alt key”, “the Caps Lock key” and “the Tab key” may be incorporated in the various key-surroundings where free space has been created by the FRM, thereby, bringing said keys into easier reach.

Yet another object of the KSM inputting device is concerned with bringing enjoyment to a heretofore burdensome and stress-related article of conventional inputting equipment. The KSM offers various freedoms such that the user is less burdened when using the KSM than when using a conventional Qwerty inputting device. With the KSM, the user is afforded space-efficiency, facilitated inputting and inputting encouragement. Secondly, the user is able to find her own uniquely comfortable position for inputting with the KSM because she may rotate, pivot and displace inputting parts and avoid causing repetitive strain injuries. Thirdly, the ability to alter her inputting area and to re-position key value placements with the KSM without altering traditional finger-to-key relationships and without making her inputting device unmanageable, allows the user to enjoy her new-found freedoms with confidence. The user is not concerned with altering her inputting device beyond the traditional key value placements with which she is familiar. Thus, the user's overall concern and tension regarding the negative effects of inputting is substantially reduced. The KSM inputting device provides freedom of inputting while it respects traditional inputting practice. Rather than being an obstacle with which to be reckoned, the KSM serves as an extension of the user's hands whereby the user need only be concerned with that which she is inputting. The KSM eliminates the disadvantages of prior art and brings enjoyment to inputting.

The novel features which are considered as characteristic for the invention are set forth in particular in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

FIG. 1a is a top plan view of the inputting device according to the present invention.

FIG. 1b is a perspective view of the inputting device according to the present invention.

FIG. 1c is a partly perspective and partly exploded side view of the inputting device according to the present invention.

FIG. 1d is a perspective view of the inputting device according to the present invention.

FIG. 2 is an exploded-layer top plan view of the inputting device according to the present invention.

FIG. 3a is a top plan view of the inputting device according to the present invention.

FIG. 3b is a cross-sectional top view of the inputting device of FIG. 3a.

FIG. 3c is a cross-sectional top view of the inputting device of FIG. 3b.

### DESCRIPTION OF THE ILLUSTRATED EMBODIMENT

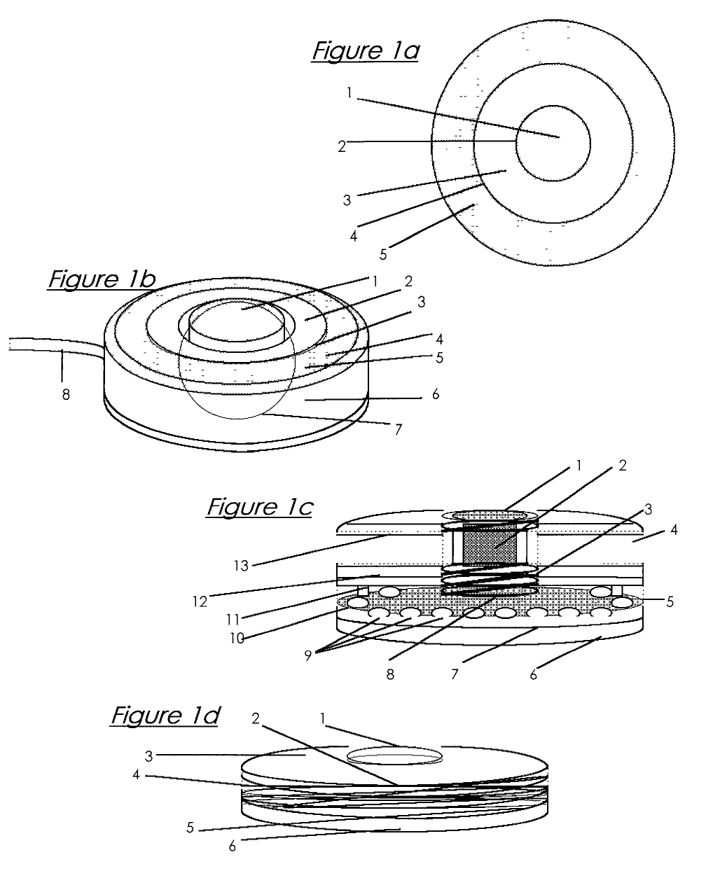

Referring to FIG. 1a, an FP-KSM embodying principles of the present invention is shown from a top plan view to have a rest-position key 1 at its focus and an optional bordering wall 2 which may separate the rest-position key from its most adjacent key-surrounding 3, an optional dividing wall 4 and in this case outermost key-surrounding 5. This two-dimensional illustration is also applicable to any touch-sensitive or touch-screen KSM inputting device.

FIG. 1b illustrates a perspective view of an FP-KSM, having rest-position key 1 at its center without a dividing wall between the focal key and key-surroundings nor one between key-surroundings. Alternatively, trackball 7 is at its center. Key-surrounding 2 has a slightly ascending angle which peaks at its outermost circumference shown at point 3 furthermost from said track ball or rest-position key. All similar points at its entire circumference is raised in height above the inner height of inner circumference of key-surrounding 5 thereby making the edge of key-surrounding 2 easier for the user to press. Key-surrounding 5 is at a height which is at an optimum at point 4 and all similar points at its entire circumference. Alternatively, such a key-surrounding may be sculpted to be raised, indented, texturized or a combination thereof at any point or points on said key-surrounding. In this case the encasing 6 is cylindrical. Trackball 7 may additionally be underneath key 1 whereby the KSM is optionally a mouse. Wire 8 transports electrical signals for the FP-KSM.

FIG. 1c is an enlarged perspective cross-sectional illustration of a key and key-surrounding exploded at areas indicated at points 4 and 5. At point 4 and in this case central and concentric key 1 is illustrated with its area of actuating construct 2 which may either be a conventional capacitive or hard-contact key actuating construct in the case of key 1 being a capacitive or hard-contact key, or a pointer-navigating device actuating construct where in an alternative 1 represents a pointer-navigating device, or a combination thereof Said actuating construct 2 fits inside cylindrical spring 3 which can alternatively be of metal or of an elastic accordion-like embodiment providing for the pivotability of key-surrounding 12 and 13. Alternatively, there may be a plurality of several spring-like apparatuses placed in a circular configuration at points similar to those of point 8 at the circumference of said spring 3, or in the alternative, the entire area above platform 10 may be comprised of an elastic or springing mass which would provide the requisite pivotability for key-surrounding 12 and 13. Platform 10 contains a plurality of actuating construct points like those similar to those indicated by 9. Above such points exemplified by 9 are corresponding actuating protrusion such as 11 floating above each of said points together forming a plurality of miniatures in this case of the conventional capacitive or hard-contact key actuating mechanism 2. Alternatively, points similar to 11 may represent the actuating contact points and the activating protrusions may be placed on platform 10 represented by points indicated by 9.

FIG. 1d is a perspective illustration of an exterior of a KSM with the central or rest-position key 1 and an accordion-like elastic or spring-like tubular structure 4 which extends about the edge of the KSM forming a connecting wall at the circumference of the top pivotable part of the KSM 3 at point 2 and similar such points, thereby, allowing one side of the KSM to extend upward as the opposite side is pressed down. Structure 4 serves to contain the floating unit, which is also connected to the surrounding base wall 6 at circumference points similar to point 5. Alternatively, the area illustrated by point 4 may also represent the outer part of an elastic or springing mass as an alternative or supplemental means for said accordion-like or cylindrical spring or said plurality of spring-like circularly configured apparatuses similar to spring 3 in FIG. 1c, where such mass would rest between platform 10 and key surrounding 13 of FIG. 1c, where said key-surrounding or said platform or a combination thereof holds an actuating surface, a plural-directional capacitive key actuating construct, plural-directional hard-contact key actuating construct, a plurality of capacitative key actuating constructs, a plurality of hard-contact key actuating constructs, a touch-sensitive surface, touch-sensitive surfaces or a combination thereof.

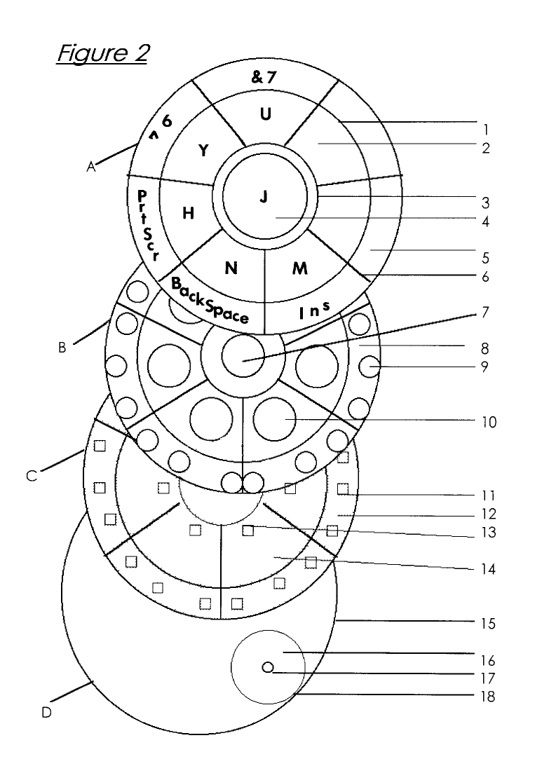

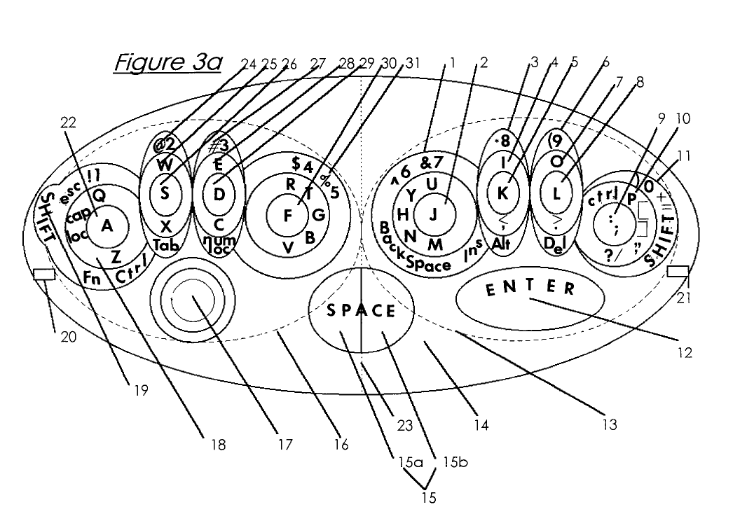

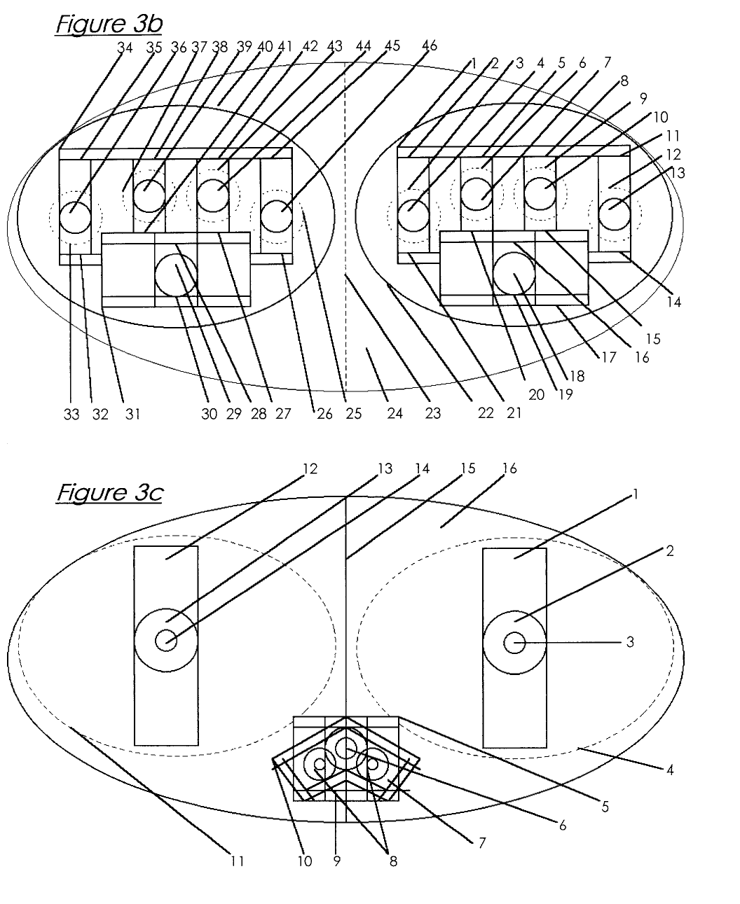

FIG. 2 is an exploded-layer top plan of a KA-KSM inputting device. At layer A, key 4, in this case the focal key, is fully surrounded by keys similar to key 2 and further surrounded by keys similar to key 5. The KA-KSM is one in this case which corresponds to an inputting device for the user's right fore-finger with the key value “J” as the rest-position key surrounded in this case with the values “U”, “Y”, “H”, “N” and “M” counter-clockwise from the top at the first key-surrounding and “&/7”, “ˆ /6”, “Prt Scr”, “Back Space” and “Ins” counter-clockwise at the furthest key-surrounding from said rest-position key. The blank KSM keys illustrate a KSM creation of space. While key values may be placed at the four blank value keys to the right of rest-position key “J”, these KA-KSM positions may be cut-out (See FIG. 3a). Borders 1,6 and 3, and all other similar ones may be structural or illustrate the edges of keys. At layer B, the layer beneath layer A, positions of in this case conventional hard-contact or capacitative key actuating constructs are illustrated at points 7,9, 10 and similar such points. There is a plurality of actuating constructs at platform 8 which may or may not actuate the same key value. Layer C illustrates the level beneath the tops of said actuating constructs of layer B. Electronically sensitive zones 11 and 13 and similar such zones lie beneath each of actuating constructs above. Alternatively, entire shaded areas 12, 14 and other similar areas may contain touch-sensitive surfaces for certain other forms of actuating devices. Layer D illustrates a support and in this case a rotational and displacing mechanism which consists of a circular wall 15 which is grooved at its interior in order to accommodate grooves at the outer edge circumference of the disk 16 at point 18 and similar such points at said circumferences. Said disk is attached at its top at point 17 to layer C and thus to the rest of the module whereas each layer is connected to its adjacently illustrated layer. Disk 16 is also attached at its other end to the base or a pod, or is extended to grooves in the base or a pod of the KSM inputting device. Said circular wall extends upward in order to contain said layers.

FIG. 3a is a top plan view of a KSM inputting device. KSM 1 has an outermost key-surrounding which is partly cut-out in order to accommodate an amount of directional inputting from rest-position key 2 given the amount of available space on the illustrated KSM inputting device. The key value “J” is the designated value for the rest-position key 2 with the values “U”, “Y”, “H”, “N” and “M” counter-clockwise from the top at the first key-surrounding and “&/7”, “ˆ /6”, “Back Space” and “Ins” at the furthest key-surrounding from rest-position key 2, all in this case in keeping with conventional Qwerty finger-to-key designations save for the “Back Space” and “Ins” keys. Rest-position keys 5 and 8 are of an oval-like shape and have similarly shaped key-surroundings 3, 4, 6 and 7 which are also in this case appropriate for conventional Qwerty key value inputting from the rest-position keys 5 and 8. Additionally, more such key-surroundings may be added to accommodate for other key values. The key values in keeping with standard inputting practice for these two rest-position keys are respectively “K” and “L” with adjacent key-surrounding key values of “I”, “</,” and “O”, “>/.” respectively. At the furthest key-surrounding in this case from the rest-position keys 5 and 8 are the key values “*/8”, “Alt” and “(/9”, “Del” respectively, all letter-character and number key values being in keeping with conventional Qwerty key value and finger-to-key relationships. Key-surroundings 3 and 6 are of a kind of KSM key-surrounding which are thin at their left and right sides. Rest-position key 9 has a partially cut-out key-surrounding 10 and neither is in this case neither concentric with the outermost crescent cut-out key-surrounding 11 of this KSM. Key-surrounding 11 is mostly devoted in this case to the key value for the “Shift” key being conventionally to the lower right of rest-position key 9 of the key value “:/;” with “)/0” and “+/=” to the upper right of rest-position key 9 all in keeping with conventional Qwerty positioning. On key-surrounding 10 are the values “Ctrl”, “P” ”}/[”, “}/], “”/”” and “?//” clockwise from the top. All these values, save for the “Ctrl” key value are in their conventional Qwerty finger-to-key relationships. The placement of the “Ctrl” key value is a use of KSM free space and could be substituted for any other key without disturbing conventional Qwerty key value positionings. Below the above-mentioned KSMs, which in this case correspond to the user's right inputting hand, is the enlarged and oval KSM key 12, which functions together with its above four KSMs, fitting in the gap on the surface of the KSM inputting device, making efficient use of new KSM space and providing a very frequently used key value with a key which can easily reached and stricken by more than one of the rest-position key fingers in this case of the user's right hand during inputting. The KSM key 12 is designated with the “Enter” key value. These right hand rest-position key KSMs are affixed to be mobile upon the right pod 13 which is in turn affixed to be mobile upon the base 14 (See description of FIG. 3b and FIG. 3c below). Key-module 15 is in this case designated with the “Space” key value and is thereby located and shaped to be reached easily by the thumbs of the user. In this case dividing line 23 indicates where the base of the KSM inputting device folds for transporting, having fixtures 20 and 21 which snap together keeping both halves interlocked. Additionally, in the case of the transportable KSM inputting device, KSM key 15 is comprised of two parts, 15a and 15b, in order to be displaced to accommodate the folding of the KSM inputting device.

Rest-position keys 26 and 29 are of an oval shape and are designated with Qwerty rest-position key values “S” and “D” respectively. These have similarly shaped key-surroundings 24, 25, 27 and 28 which are also in this case appropriate for conventional Qwerty key value inputting from rest-position keys 26 and 29. These keys are of values “@/2” and “Tab”, “W” and “X”, “#3” and “Num lock”, and “E’ and “C” respectively. The blank value on these key-surroundings illustrates a KSM creation of free space and can be designated with any key value which will not conflict with conventional Qwerty key value positionings. Additionally, more such key-surroundings may be added to accommodate the addition of even more key values. Key-surroundings 24 and 27 are of a kind of KSM key-surrounding which are thin at their left and right sides. Rest-position key 30 is of the key value “F” with its most adjacent key-surround having key values “R”, “T”, “G”, “B” and “V” clockwise from the top. These letter-character key values are in their proper conventional Qwerty key value relation with rest-position key value “F” save for the key value “B”. This key value has been placed on this key-surrounding instead of on that most adjacent to rest-position key 2 in order to give an even distribution of key values to each of the two fore-finger rest-position keys. However, the “B” key value may be designated to either of these rest-position keys. Key-surrounding 31 is partially cut-out and has key-values “$/4” and “%/5” in the conventional Qwerty key value positioning. The empty space on this key-surround may be substituted with a plurality of values and illustrates the availability of KSM free space. Rest-position key 22 has a partially cut-out key-surrounding 18 and in this case neither is concentric with the outermost amorphous key-surrounding 19 of this KSM. The entire left-most part of key-surrounding 19 is devoted in this case to the Qwerty key value for the “Shift” key which is conventionally to the left of rest-position key 22 of key value “A”. Also designated to this key-surrounding are values “Esc” and “!/1” at its top and “Fn” and “Ctrl” at its bottom. The value for “!/1” is in the conventional Qwerty position with respect to rest-position key 22. The “Esc” key value is placed at the left upper part of inputting devices conventionally. The key-surrounding most adjacent to the rest-position key 22 contains Qwerty values “Q” at its top and “Z” at its bottom in keeping with conventional relationship to the rest-position key value “A”. The value for “Cap Lock” on this key-surrounding is a use of the KSM free space and may be substituted for another from a plurality of key values. Below the above-mentioned KSMs, which in this case correspond to the user's left inputting hand, is the cursor-navigating device KSM 17, which functions together with its above four KSMs, fitting in the gap on the surface of the KSM inputting device, and making efficient use of available KSM space in providing a KSM key which can be manipulated by any one of the user's rest-position key fingers. The key-surroundings of KSM 17 may be utilized for the values of “PgUP′, PgDn”, “Home” and “End”, and the four “Arrow keys” separately whereas these are values associated with direction similar to the concern of the cursor-navigating device and thereby will be easier for the user to recall while inputting. KSMs are affixed to be mobile upon the left pod 16 which is in turn affixed to be mobile upon the base 14 (See description of FIG. 3c below). KSM 17 is in this case designated as the cursor-navigating KSM.

Although in FIG. 3a all KSMs are illustrated as being FP-KSMs with keys, KSM keys and floating pivotable key-surroundings, alternatively any or all of these or parts thereof may be substituted with other FP-KSMs, keys, KSM keys, floating pivotable key-surroundings, KA-KSMs, keys, KSM keys or parts thereof or a combination thereof Additionally, areas of KSM free space may be utilized for the disbursement of existing key values upon their assigned keys, hence, designating more inputting area to these existing key values.

FIG. 3b is a cross-sectional top view with pods 40 and 22 each on either side of the division line 23 of the base 24 of a KSM inputting device. Within path frame 1 of right pod 22 there are four pathways which move within said path frame horizontally at point pairs 2 and 21, 5 and 20, 8 and 15, and, 11 and 14. Inside these pathways are cylindrical stems which are at their tops connected to KSMs 3,6,9 and 12, which rotate and which move vertically within said pathways. These four correspond to the four rest-position key KSMs of pod 13 of FIG. 3a. Separate path frame 17 contains a single pathway which moves horizontally at points 16 and 19 within said path frame. In this pathway cylindrical stem 18 rotates and moves vertically and in this case would at its top be connected to the KSM key which corresponds to that of the “Enter” key 12 in FIG. 3a. Likewise, within path frame 34 of the left pod 40 there are four pathways which move within said path frame horizontally at point pairs 35 and 32, 38 and 41, 42 and 27, and, 45 and 26. Inside these pathways are cylindrical stems which are at their tops connected to KSMs 33, 37, 43 and 25, which rotate and which move vertically within said pathways. These four correspond to the four rest-position key KSMs of pod 16 of FIG. 3a. Separate path frame 31 contains a single pathway which moves horizontally at points 28 and 30. In said pathway cylindrical stem 29 rotates and moves vertically and in this case would at its top be connected to a KSM which corresponds to that of the cursor-navigating KSM 17 in FIG. 3a.

FIG. 3c is a cross-sectional top view of the base 16 of the KSM inputting device beneath pods 4 and 11 which correspond to pods 22 and 40 of FIG. 3b respectively. Beneath pod 4 is a path frame 1 inside which rotates and travels vertically a cylindrical stem 2 which is at its upper portion attached to pod 4 at point 3. Beneath pod 11 is path frame 12 inside which rotates and travels vertically a cylindrical stem 13 which is at its upper portion attached to pod 11 at point 14. Path frame 5 contains a pathway 9 which moves horizontally within said path frame. Within said pathway 9 is a cylindrical stem 6 which rotates and travels vertically inside said pathway. Stem 6 is attached in this case to the “Space” key 15 described in FIG. 3a. In the alternative, and with regard to the KSM inputting device which has fold 15 and necessarily a “Space bar” which is separable into two parts to accommodate such folding, twin cylindrical stems 8, rotate and travel in the direction set by path frame 10 and pathway 7.

It will be understood that each of the elements described above, or two or more together, may also find a useful application in other types of constructions differing from the types described above. And while the invention has been described and illustrated as embodied in inputting devices, it is not intended to be limited to the details shown, since various modifications and structural changes may be made without departing in any way from the spirit of the present invention.

Without further analysis, the foregoing will so fully reveal the essence of the present invention that others can, by applying current knowledge, readily adapt it for various applications without omitting features that, from the standpoint of prior art, fairly constitutes essential characteristics of the generic or specific aspects of this invention.

What is claimed as new and desired to be protected by Letters Patent is set forth in the appended claims.

I claim:

1. A key-surround module inputting device comprised of
a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-direction pivotable key-surrounding as below, floating plural-direction pivotable inputting key-surroundings, a key-arrangement inputting key-surrounding as below, key-arrangement inputting key-surroundings or a combination thereof, and
a floating plural-direction pivotable inputting key-surrounding, floating plural-direction pivotable inputting key-surroundings, a key-arrangement inputting key-surrounding, key-arrangement inputting key-surroundings, a touch-sensitive surface or touch-sensitive surfaces including but not limited to a touch-screen, a screen or monitor display, screen or monitor displays, or a combination thereof, not limited to resting concentric with regard to the above or to each other, not limited to surrounding the above, and not limited to being circular in shape, with a capacitive key actuating construct, an hard-contact key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch sensitive surfaces or a combination thereof beneath.

2. A key-surround module inputting device comprised of
a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-direction pivotable key-surrounding as below, floating plural-direction pivotable inputting key-surroundings, a key-arrangement inputting key-surrounding as below, key-arrangement inputting key-surroundings or a combination thereof, and
a floating plural-direction pivotable inputting key-surrounding, floating plural-direction pivotable inputting key-surroundings, a key-arrangement inputting key-surrounding, key-arrangement inputting key-surroundings, a touch-sensitive surface or touch-sensitive surfaces including but not limited to a touch-screen, a screen or monitor display, screen or monitor displays, or a combination thereof, not limited to resting concentric with regard to the above or to each other, not limited to surrounding the above, and not limited to being circular in shape, with a capacitive key actuating construct, an hard-contact key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch-sensitive surfaces or a combination thereof beneath, and
a support or supports which contains or contain the above, individually, in any unit, in units or a combination thereof, enabling any of the above to rotate individually, in any unit, in units or a combination thereof enabling any of the above to be displaced in a plurality of directions, individually, in any unit, in units or a combination thereof, enabling any of the above to be made concentric or non-concentric with respect to any of the above individually, in any unit, in units or a combination thereof, or a combination thereof.

3. A key-surround module inputting device comprised of
a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-directional pivotable key-surrounding as below, floating plural-directional pivotable key-surroundings, a key-arrangement key-surrounding as below, key-arrangement key-surroundings or a combination thereof, and
a floating plural-direction pivotable inputting key-surrounding, floating plural-direction pivotable key-surroundings, a key-arrangement key-surrounding, key-arrangement key-surroundings or a combination thereof, a touch-sensitive surface or touch-sensitive surfaces including but not limited to a touch-screen, a screen or monitor display, screen or monitor displays, or a combination thereof, not limited to being concentric with regard to the above, not limited to surrounding the above and not limited to being circular in shape, having a capacitive key actuating construct, an hard contact actuating key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch-sensitive surfaces or a combination thereof beneath, and
whereas said capacitive key, capacitive keys, an hard-contact key, hard-contact keys, a pointer-navigating device, pointer-navigating devices, a trackball, trackballs, a touch-sensitive surface, touch-sensitive surfaces including but not limited to a touch-screen, a screen or monitor display, screen or monitor displays, a floating plural-direction pivotable key-surrounding, as above, floating plural-direction pivotable key-surroundings, a key-arrangement key-surrounding, key-arrangement key-surroundings or any combination thereof is or are manually or automatically adjustable with regard to concentricity amongst or between each other, or, is or are further comprised of a support or supports and extension or extensions beneath and a primary plate or primary plates beneath said extension or extensions containing a channel or channels by which said extension or extensions enable modular travel in a plurality of direction thereby allowing said inputting device to be reconfigured in a plurality of direction, allowing rotation and displacement for the unique comfort of any user, or, is or are further comprised of a secondary extension or secondary extensions beneath and a secondary plate or secondary plates beneath said secondary extension or secondary extensions containing a channel or channels by which said secondary extension or secondary extensions enable modular travel in a plurality of direction thereby allowing said primary plates or primary plates to be moved in any direction and to be rotated separately or in unison, or a combination thereof.

4. A key-surround module inputting device comprised of
a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-direction pivotable key-surrounding as below, floating plural-direction pivotable inputting key-surroundings, a key-arrangement inputting key-surrounding as below, key-arrangement inputting key-surroundings or a combination thereof, and
a floating plural-direction pivotable inputting key-surrounding, floating plural-direction pivotable inputting key-surroundings, a key-arrangement inputting key-surrounding, key-arrangement inputting key-surroundings, a touch-sensitive surface or touch-sensitive surfaces including but not limited to a touch-screen, a screen or monitor display, screen or monitor displays, or a combination thereof, not limited to resting concentric with regard to the above or to each other, not limited to surrounding the above, and not limited to being circular in shape, with a capacitive key actuating construct, an hard-contact key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch-sensitive surfaces or a combination thereof beneath, and
a support or supports which contains or contain the above, individually, in any unit, in units or a combination thereof, enabling any of the above to rotate individually, in any unit, in units or a combination thereof, enabling any of the above to be displaced in a plurality of directions, individually, in any unit, in units or a combination thereof, enabling any of the above to be made concentric or non-concentric with respect to any of the above individually, in any unit, in units or a combination thereof, or any combination thereof.

5. An inputting device according to claim 4, further comprised of a motor or motors which provide said displacement and rotation automatically.

6. An inputting device according to claim 5, wherein said motor or motors is or are controlled by a computer which directs movement and rotation, and stores positions of the computer inputting device, thereby, allowing users to reconfigure and to recall positions the computer inputting device.

7. An inputting device according to claim 6, wherein the surface beneath said support, supports or a combination thereof, are part of a hinged folding or overlapping surface or surfaces which snap together, thereby, allowing the computer inputting device to be made more compact and portable.

8. A key-surround module inputting device comprised of
a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-directional pivotable key-surrounding as below, floating plural-directional pivotable key-surroundings, a key-arrangement key-surrounding as below, key-arrangement key-surroundings or a combinations thereof, and
a floating plural-direction pivotable inputting key-surrounding, floating plural-direction pivotable key-surroundings, a key-arrangement key-surrounding, key-arrangement key-surroundings or a combination thereof, a touch-sensitive surface or touch-sensitive surfaces including but not limited to a touch-screen, a screen or monitor display, screen or monitor displays, or a combination thereof, not limited to being concentric with regard to the above, not limited to surrounding the above and not limited to being circular in shape, having a capacitive key actuating construct, an hard contact actuating key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch-sensitive surfaces or a combination thereof beneath, and
whereas said capacitive key, capacitive keys, an hard-contact key, hard-contact keys, a pointer-navigating device, pointer-navigating devices, a trackball, trackballs, a touch-sensitive surface, touch-sensitive surfaces including but not limited to a touch-screen, a screen or monitor display, screen or monitor displays, a floating plural-direction pivotable key-surrounding, as above, floating plural-direction pivotable key-surroundings, a key-arrangement key-surrounding, key-arrangement key-surroundings or any combination thereof is or are manually or automatically adjustable with regard to concentricity amongst or between each other, or, is or are further comprised of a support or supports and extension or extensions beneath and a primary plate or primary plates beneath said extension or extensions containing a channel or channels by which said extension or extensions enable modular travel in a plurality of direction thereby allowing said inputting device to be reconfigured in a plurality of direction, allowing rotation and displacement for the unique comfort of any user, or, is or are further comprised of a secondary extension or secondary extensions beneath and a secondary plate or secondary plates beneath said secondary extension or secondary extensions containing a channel or channels by which said secondary extension or secondary extensions enable modular travel in a plurality of direction thereby allowing said primary plates or primary plates to be moved in any direction and to be rotated separately or in unison, or a combination thereof.

9. An inputting device according to claim 8, further comprised of a motor or motors which provide said movement and rotation automatically.

10. An inputting device according to claim 9, wherein said motor or motors are controlled by a computer which directs movement and rotation, and stores positions of the computer inputting device, thereby, allowing users to reconfigure and to recall positions the inputting device.

11. An inputting device according to claim 10, wherein the surface beneath said secondary plate or plates are part of a hinged folding or overlapping surface or surfaces which snap together, thereby, allowing the inputting device to be made more compact and portable.

12. A key-surround module inputting device comprised of a plurality of floating plural-direction pivotable inputting key-surrounding or key-arrangement key-surrounding module or modules, each having a capacitive key, capacitive keys, an hard-contact key, hard-contact keys, a pointer-navigating device, pointer-navigating devices, a trackball, trackballs, a touch-sensitive surface or touch-sensitive surfaces including but not limited to a touch-screen, a screen or monitor display, screen or monitor displays, a floating plural-direction pivotable inputting key-surrounding as below, floating plural-direction pivotable inputting key-surroundings, a key-arrangement inputting key-surrounding as below, key-arrangement inputting key-surroundings or a combination thereof, and
a floating plural-direction pivotable inputting key-surrounding, floating plural-direction pivotable inputting key-surroundings, a key-arrangement inputting key-surrounding, key-arrangement inputting key-surroundings or combination thereof, not limited to being concentric with regard to the above, not limited to surrounding the above and not limited to being circular in shape, with a capacitive key actuating construct, an hard-contact key actuating construct, a plural-directional capacitive key actuating construct, a plural-directional hard-contact key actuating construct, a plurality of capacitative key actuating constructs, a plurality of hard-contact key actuating constructs, a touch-sensitive surface, touch-sensitive surfaces or a combination thereof beneath.

13. An inputting device according to claim 12, further comprised of a capacitive key, capacitive keys, an hard-contact key, hard-contact keys, a pointer-navigating device, pointer navigating devices, a trackball, trackballs, a touch-sensitive surface or touch-sensitive surfaces including but not limited to a touch-screen, a screen or monitor display, screen or monitor displays, a key-surrounding, key-surroundings or any combination thereof which is or are manually or automatically adjustable with regard to concentricity amongst or between each other.

14. An inputting device according to claim 13, further comprised of a support or supports and extension or extensions beneath said key-surrounding, key-surroundings, key-surrounding module, key-surrounding modules or a combination thereof and a primary plate or primary plates beneath said extension or extensions containing a channel or channels by which said extension or extensions enable modular travel in a plurality of direction, thereby, allowing said key-surrounding module or modules, in whole or in part, to be moved in a plurality of direction and to be rotated, allowing said inputting device to be adjustable for the unique comfort of any user.

15. An inputting device according to claim 14, further comprised of a capacitive key, capacitive keys, an hard-contact key, hard-contact keys, a pointer-navigating device, pointer navigating devices, a trackball, trackballs, a touch-sensitive surface, touch-sensitive surfaces not limited to a touch-sensitive screen, a screen or monitor display, screen or monitor displays, or a combination thereof, module or modules, with a support and extension or extensions beneath said module or modules and a primary plate or primary plates beneath said extension or extensions containing a channel or channels by which said extension or extensions enable modular travel in a plurality of direction, thereby, allowing said modules to be moved in a plurality of direction and to be rotated, allowing said device to be adjustable for the unique comfort of any user and complimenting the positioning of other said key-surrounding module or modules or components thereof.

16. An inputting device according to claim 15, wherein said primary plate or primary plates holds or hold a plurality of said modules, having a secondary extension or secondary extensions beneath and a secondary plate or secondary plates beneath said extension or extensions containing a channel or channels by which said secondary extension or secondary extensions enable modular travel in a plurality of direction, thereby, allowing a plurality of modules to be moved in a plurality of direction and to be rotated in unison.

17. An inputting device according to claim 16, wherein the surface beneath said secondary plate or secondary plates are part of hinged, folding, overlapping, interlocking surface or surfaces or a combination thereof, thereby, allowing the inputting device to be made more compact and portable.

18. An inputting device according to claim 17, wherein said key-surround, key-surrounds, module, modules, respective parts, components or a combination thereof are moved by means of a motor or motors, thereby, allowing automatic movement and rotation of the inputting device.

19. An inputting device according to claim 18, wherein said motor or motors are controlled by a computer which directs motor movement and stores positions of said module, modules, plate, plates, respective components or a combination thereof in its memory, thereby, allowing users to change positions of said module, modules, plate, plates, or respective components or a combination thereof, thereby, allowing the user to quickly and effortlessly change and recall positions of the inputting device.
